(19) United States
(12) Patent Application Publication
(10) Pub. No.: US 2014/0335233 A1
(43) Pub. Date: Nov. 13, 2014

(54) ASPARAGUS CONTAINERS AND RELATED METHODS

(71) Applicants: Lonnie Duwyn, Delhi (CA); Philip Raymond Short, Vineland Station (CA); Xie Fu Song, Shantou (CN)

(72) Inventors: Lonnie Duwyn, Delhi (CA); Philip Raymond Short, Vineland Station (CA); Xie Fu Song, Shantou (CN)

(21) Appl. No.: 14/274,342

(22) Filed: May 9, 2014

Related U.S. Application Data
(60) Provisional application No. 61/822,015, filed on May 10, 2013.

(51) Int. Cl. B65D 85/50; A23L 1/212; B65B 25/04; B65D 6/00

(52) U.S. Cl. CPC B65D 85/50; B65D 11/105; B65D 11/20; A23L 1/212; B65B 25/041; A23V 2002/00
USPC 426/106; 206/205; 220/602; 220/676; 53/431

(57) ABSTRACT

Asparagus spears may be stored and displayed for sale, and sold, in individual containers having a reservoir containing a volume of water, with a group of asparagus spears arranged in the container such that their white tips are in contact with the volume of water. This allows the asparagus spears to be moved from a retail display, to a shopping cart, to a shopping bag, and eventually to a customer's home, without having to remove the white tips of the asparagus from contact with the water. One exemplary container has a waist between the first end and the second end of the container and tapers inwardly from the waist toward the first end and toward the second end. This tapering shape permits air to flow between adjacent containers when the containers are packed together for shipping.

### CROSS-REFERENCE TO RELATED APPLICATION

This application claims priority to U.S. Provisional Application No. 61/822,015 filed on May 10, 2013, the teachings of which are hereby incorporated by reference.

### TECHNICAL FIELD

The present disclosure relates to produce containers, and more particularly to containers for asparagus and to related methods.

### BACKGROUND

Asparagus is a spring vegetable enjoyed by many people either alone, for example steamed asparagus as a side dish, or as an ingredient in other dishes, such as various tasty asparagus dips which may be served with chips.

To best preserve asparagus, it should be stored upright with the white tip at the base of the stem resting in water. As such, when presented for sale in grocery stores, individual asparagus spears are often grouped into bundles held together by an elastic, with the bundles arranged upright in a pool of water such that the white tips are disposed in the water. Although this arrangement preserves the asparagus while it is on display, taking a bundle of asparagus for purchase results in removal of the white tip from the pool of water. Although the asparagus bundle may be placed in a new pool of water (e.g. in a jar or other container) when the customer arrives home, a customer may not know to do so or may forget. Even if a customer knows and remembers that the asparagus should be placed in water, this adds yet another step to the drudgery of unpacking groceries.

### SUMMARY

Asparagus spears may be stored and displayed for sale, and sold, in individual containers having a reservoir containing a volume of water, with a group of asparagus spears arranged in the container such that their white tips rest in contact with the volume of water. This allows the asparagus spears to be moved from a retail display, to a shopping cart, to a shopping bag, and eventually to a customer's home, without having to remove the white tips of the asparagus from contact with the water.

In one aspect, a container for asparagus has a first end and a second end and a waist disposed between the first end and second end, and the container tapers inwardly from the waist toward the first end and from the waist toward the second end. The container has a reservoir for containing a volume of water, and the container is ventilated.

A quantity of water may be disposed in the reservoir, and at least one asparagus spear may also be disposed in the container, with each asparagus spear having its white tip in contact with the water. Preferably, each asparagus spear extends substantially transverse to the waist.

In an embodiment, the container comprises a base defining the first end of the container and a lid defining the second end of the container, with the lid being removably securable to the base and at least one of the lid. The base forms the reservoir, and may be ventilated.

The waist may be formed at a junction between the lid and the base.

An assembly may be formed comprising a container as described above and a handle carried by the container for supporting the container during transport. In one embodiment, the handle is carried by the lid.

In one embodiment, the container has, in cross-section taken through the waist, a substantially triangular profile.

A periphery of the base adjacent the first end of the container is adapted for obscuring white tips of asparagus. In one embodiment, the periphery of the base is covered by an adhesive label. The base may be substantially non-transparent and the lid may be transparent.

In one embodiment, the base includes ventilation and the reservoir is disposed between the ventilation and the first end of the container.

The container may have a marketing label disposed thereon.

In another aspect, a method of storing asparagus for sale comprises storing a plurality of groups of asparagus spears, wherein each group of asparagus spears is disposed in a respective individual ventilated container, each container has a reservoir containing a respective volume of water, the white tips of the asparagus spears are disposed in contact with the respective volumes of water, and the containers substantially enclose the respective groups of asparagus spears.

In a further aspect, a method of packaging asparagus for sale comprises providing a container base, the container base forming a reservoir for containing a volume of water, placing at least one asparagus spear in the container base and placing a volume of water in the reservoir. According to the method, when the at least one asparagus spear is in the container base and the volume of water is in the reservoir, each white tip of the at least one asparagus spear is disposed in contact with the volume of water while a major portion of the at least one asparagus spear is disposed outside the volume of water. The method further comprises removably securing a container lid to the container base to form a complete container, with the complete container substantially enclosing the at least one asparagus spear and at least one of the lid and the base is ventilated.

The method may further comprise transporting the container, with the at least one asparagus spear disposed therewithin, to a retail environment, and may still further comprise displaying the container, with the at least one asparagus spear disposed therewithin, in the retail environment.

Containers used in implementing the methods may be as described above.

### BRIEF DESCRIPTION OF THE DRAWINGS

These and other features will become more apparent from the following description in which reference is made to the appended drawings wherein:

FIG. 1 is a top perspective view of an exemplary container;

FIG. 2 is a side elevation view of the container of FIG. 1;

FIG. 3 is a bottom plan view of the base of the container of FIG. 1;

FIG. 4 is a side elevation view of the base of FIG. 3;

FIG. 5 is a top perspective view of the base of FIG. 3;

FIG. 6 is a top perspective view of a first alternative embodiment of a base;

FIG. 7 is a top perspective view of a second alternative embodiment of a base;

FIG. 8 is a top plan view of an exemplary lid of the container of FIG. 1;

FIG. 9 is a side elevation view of the lid FIG. 8;

FIG. 10 is a bottom perspective view of the lid of FIG. 8;

FIG. 11 is a side elevation view of the container of FIG. 1 with water and a plurality of asparagus spears disposed therein;

FIG. 12 is a flow chart showing an exemplary method of preparing asparagus for sale; and

FIG. 13 shows a method of storing asparagus for sale while displaying the asparagus within a retail environment.

### DETAILED DESCRIPTION

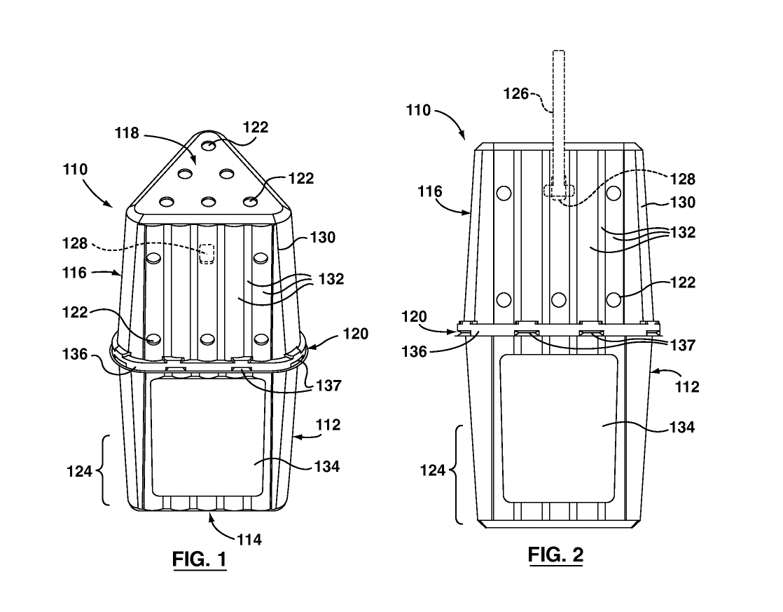

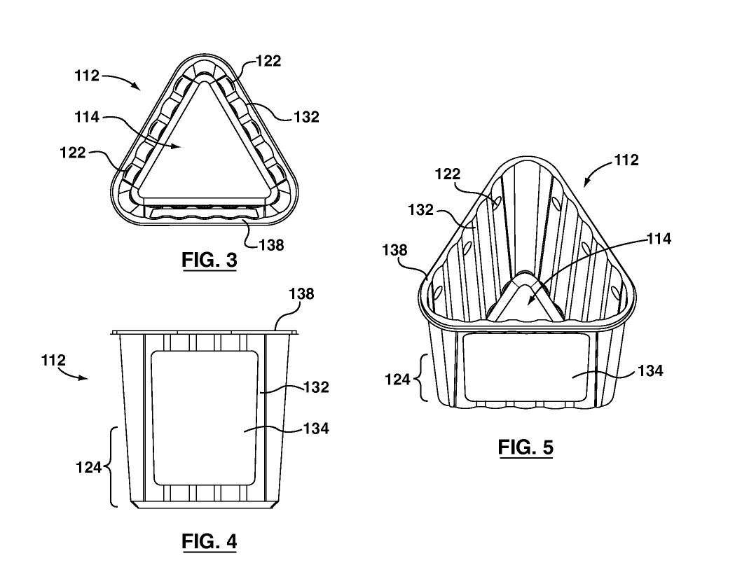

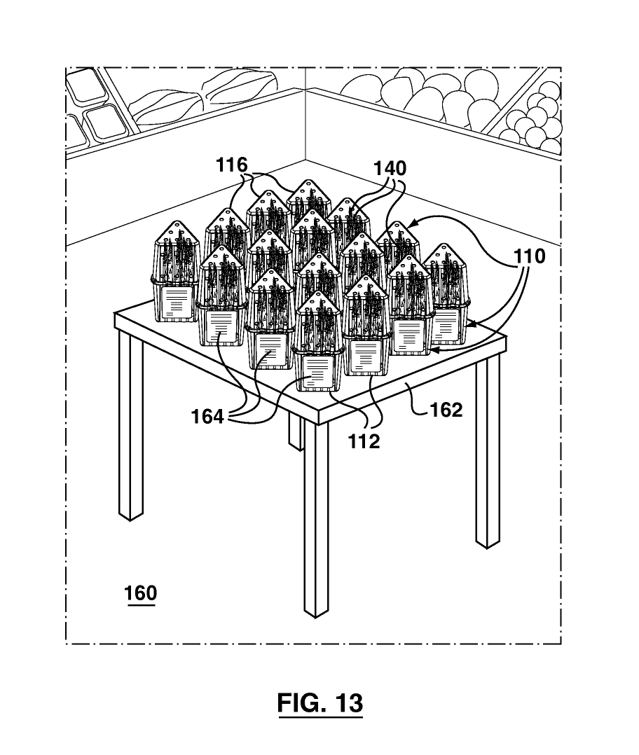

Reference is now made to FIGS. 1 and 2, which show an exemplary container for asparagus, which is indicated generally at 110. The container 110 comprises a base 112 defining a first end 114 of the container 110. The container 110 further comprises a lid 116 defining a second end 118 of the container 110. In the illustrated embodiment the container 110 has a waist 120 formed at the junction between the lid 116 and the base 112; in other embodiments the waist may be at a position other than the junction. The waist 120 is positioned between the first end 114 and the second end 118 and, from the waist 120, the container 110 tapers inwardly toward the first end 114 and also tapers inwardly toward the second end 118. The tapering may be symmetrical or asymmetrical. The tapering shape permits air to flow between adjacent containers 110 when the containers 110 are packed together for shipping or arranged closely together in a retail environment. In the illustrated embodiment, the container sidewall 130 (formed by both the base 112 and the lid 116) is crenated by alternating outwardly and inwardly impressed regions to define a plurality of strengthening ribs 132. The strengthening ribs 132 located on the container sidewall 130 are omitted from a smooth region 134 on one sidewall 130 of the base 112; a label, such as a marketing label 164 (see FIG. 13), may be adhered to this smooth region 134.

FIG. 2 shows an assembly in which the container 110 is combined with an optional handle 126; in the illustrated embodiment the handle is carried by the lid 116. The handle 126 supports the container 110 during transport. For instance, a customer could use the handle to transport the container 110 from a retail display to a shopping cart, or from a refrigerator to a kitchen counter. In other embodiments, the handle 126 may be carried by the base 112 rather than by the lid 116. Although in the exemplary drawing the handle 126 is shown as inserted into an optional aperture 128 in the lid 116, a handle, when present, may be secured to the lid 116 or base 112 by any suitable technique or structure. For example, the recess arrangement taught by United States Patent Application Publication No. 2013/0206784 A1 entitled “Container with Recessed Handle Cavities” could be used for securing the handle to the lid. As another example, a paper or plastic film handle could be taped, glued or welded to the base or the lid. Alternatively, the container may not be provided with a handle.

Reference is now made to FIGS. 3, 4, and 5 which respectively show a bottom plan, side elevation, and top perspective view of the exemplary base 112. The base 112 includes ventilation by way of a plurality of apertures 122. These apertures 122 permit air flow in the containers 110 to maintain freshness of the asparagus during storage. The base 112 also forms a reservoir 124 for containing a volume of water. This reservoir 124 is disposed between the ventilation (created by the apertures 122) in the base 112 and the first end 114 of the container 110. By providing a reservoir 124, containers as described herein enable the white tips of the asparagus to rest in contact with water for improved longevity.

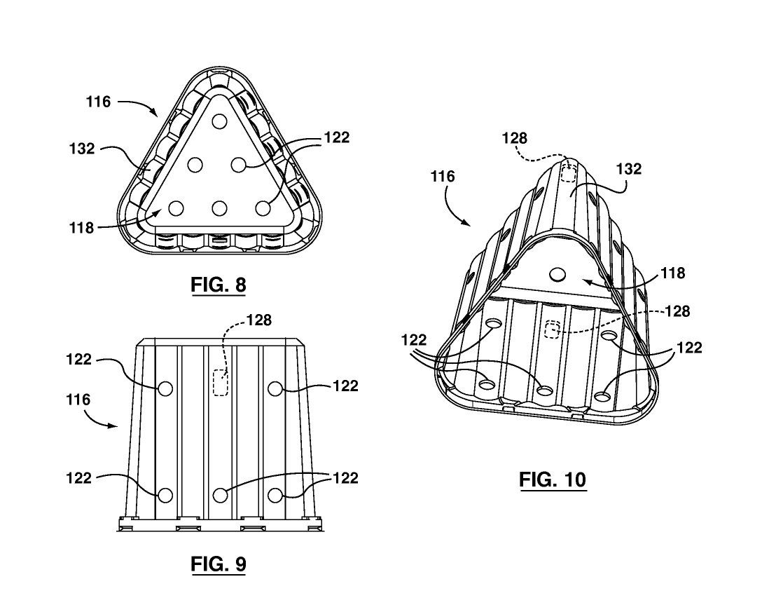

As can be seen in FIGS. 3 and 5 (as well as FIGS. 8 and 10) in a preferred embodiment the container has, in cross-section taken through the waist, a substantially equilateral triangular profile. This substantially equilateral triangular profile is efficient because it permits a plurality of the containers 110 to be efficiently packed in a larger shipping container or retail display while, as described above, the inward tapering from the waist 120 toward the first end 114 and toward the second end 118 creates some space between adjacent containers 110 for airflow to improve storage for the asparagus. Although the illustrated embodiment features a substantially equilateral triangular profile because this shape is particularly advantageous, the cross-sectional profile could alternatively be substantially circular, oval, rectangular, or have other suitable shapes.

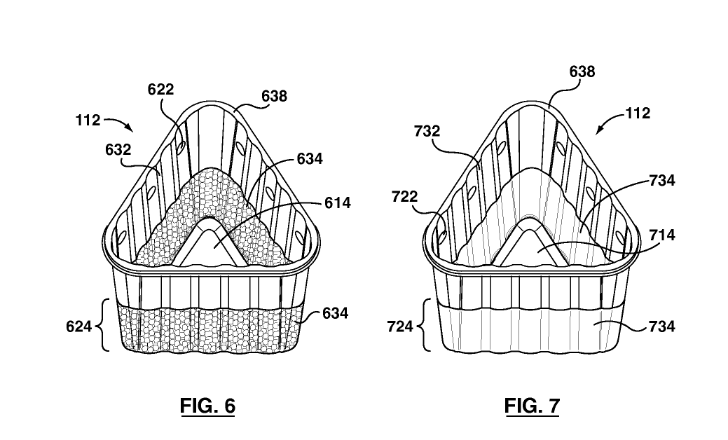

Optionally, containers as taught herein may include an opaque, substantially opaque, translucent or otherwise substantially non-transparent element or region to obscure the white tips at the bases of the asparagus stems. Reference is now made to FIGS. 6 and 7, in which corresponding reference numerals refer to corresponding features, except with the prefix “6” or “7”, respectively, instead of “1”. In FIG. 6, a textured region 634 may extend around the periphery of the base 612 adjacent the first end 614 of the container 612 with the textured region being adapted to obscure the white tips at the bases of the asparagus stems. The container is preferably formed from a transparent material, and the texture would be such as to render the textured region substantially opaque or translucent. Alternatively, as shown in FIG. 7, the strengthening ribs 732 are omitted from, or reduced in depth within, a smooth region 734 which wraps around the corners of the base 712 and extends around the periphery of the base 712 adjacent the first end 714 of the container. A substantially opaque adhesive label may be adhered to the smooth region 734 for obscuring the white tips of the asparagus. The smooth region 734 or textured region 634 may be provided on containers having other cross-sectional shapes as well. In a further alternative embodiment, the lid may be formed from a transparent material and the base may be formed from an opaque, translucent or otherwise substantially non-transparent material. Preferably, the container is formed from recyclable plastic.

Reference is now made to FIGS. 8, 9, and 10 which respectively show a top plan, side elevation, and top perspective view of the exemplary lid 116. The lid 116 is ventilated by a plurality of apertures 122. These apertures 122 permit air flow in the containers 110. Thus, in the illustrated embodiment both the container lid 116 and the container base 112 are ventilated; in other embodiments only the lid may be ventilated or only the base may be ventilated, depending on the relative size and configuration of the base and lid.

The lid 116 may be removably secured to the base 112 by any suitable releasable interengagement mechanism. In the illustrated embodiment, as best seen in FIGS. 1, 2, 4 and 9, the lid 116 has an outwardly projecting skirt 136 at its open end, with a plurality of fingers 137 projecting inwardly from the skirt 136 to engage an outwardly projecting lip 138 at the open end of the base 112 in a snap fit. Other types of removable securement may also be used. For example, in one contemplated embodiment, the height of the container may be greater than the length of the asparagus spears, and the lid may be a sheet of suitable plastic film that is peelably adhered to an annular rim at the top of the base to complete the container. Thus, the base and the lid need not be the same height. In alternative embodiments, the lid may be an open-topped lid.

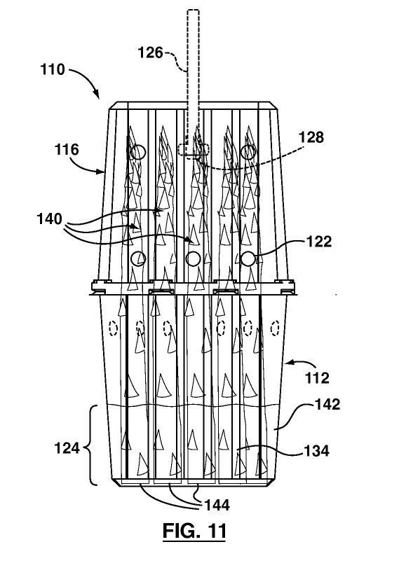

FIG. 11 shows a group of exemplary asparagus spears 140 disposed in the container 110, with a quantity of water 142 disposed in the reservoir 124. The asparagus spears 140 have their white tips 144 resting in the water 142, adjacent the first end 114 of the container, and the asparagus spear 140 extends substantially transverse to the waist 120. This upright positioning of the asparagus 140 allows for better preservation of asparagus during storage. Although FIG. 11 illustrates the water 142 as a pool of water contained by the reservoir 124, in alternate and equivalent embodiments the water may be contained by a saturated moisture pad, sponge or other water storage element disposed in the reservoir, with the white tips of the asparagus resting in contact with the moisture pad, sponge, or other water storage element and hence in contact with the volume of water. Using a moisture pad, sponge, or other water storage element to contain the volume of water reduces the risk that water will escape (e.g. through the apertures 122) should the container 110 tip over.

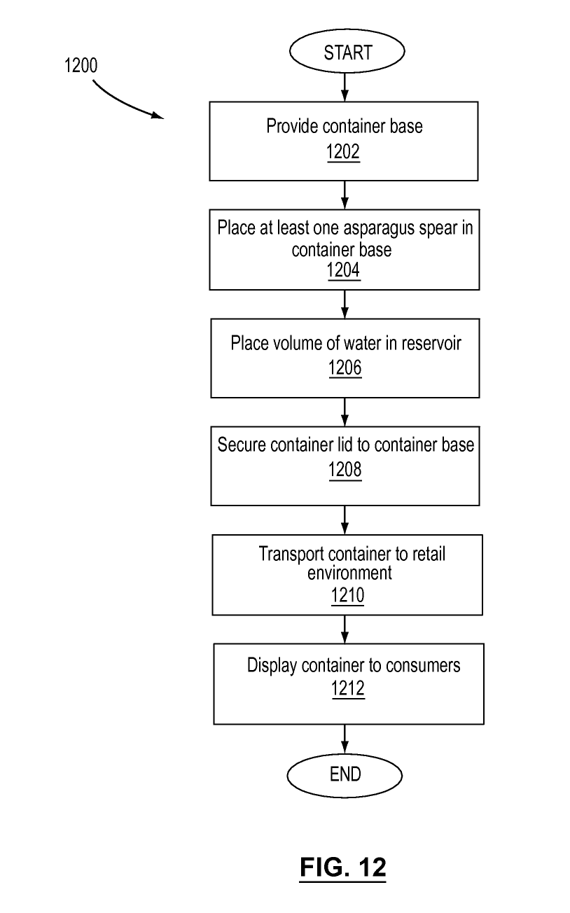

Containers as described herein enable a method for packaging, distributing and displaying asparagus at retail. Thus, a method of preparing asparagus for sale, denoted generally by reference 1200 in FIG. 12, comprises the following steps. At step 1202, a container base, for example the base 12, is provided. Thus, the container base provided at step 1202 forms a reservoir for containing a volume of water. At step 1204, at least one asparagus spear, and preferably a plurality of asparagus spears, is placed in the container base, and at step 1206 a volume of water is placed in the reservoir. Steps 1204 and 1206 may be performed in reverse order or substantially simultaneously, for example by an automated process. Upon completion of steps 1204 and 1206, when the at least one asparagus spear is in the container and the volume of water is in the reservoir, each white tip of the asparagus spear(s) is disposed in contact with the volume of water while a substantial portion of the length of each asparagus spear, preferably at least 40%, more preferably at least 50%, still more preferably at least 60% and even more preferably at least 70% of the length, is disposed outside, that is, not in contact with, the volume of water. At step 1208, a container lid, such as the container lid 116, is removably secured to the container base to form a complete container, such as the container 110. As noted above, at least one of the container lid and the container base is ventilated. As can be seen in FIG. 11, the complete container preferably substantially encloses the asparagus spear(s). At step 1210, the container with the stored asparagus disposed therewithin is transported to a retail environment where, at step 1212, it can be displayed to customers.

FIG. 13 shows a method of storing asparagus for sale while displaying the asparagus within a retail environment 160, such as a supermarket. As can be seen, a plurality of groups of asparagus spears 140 are provided, with each group of asparagus spears 140 disposed in a respective individual ventilated container 110; thus a plurality of individual containers 110 are arranged on a display surface 162 with each container 110 containing a group of asparagus spears 140. As such, each group of asparagus spears 140 is in a different respective individual container 110. As explained above in respect of FIG. 11, each container 110 has a reservoir 124 containing a respective volume of water 142 and the white tips 144 of the asparagus spears 140 are disposed in the respective volumes of water 142 and the containers 110 substantially enclose the respective groups of asparagus spears 140. Because each asparagus container 110, or at least the lid thereof, is preferably made of a transparent material such as plastic, the containers 110 with the stored asparagus 140 are attractively displayed for the customer. In the exemplary embodiment shown in FIG. 13, each container 110 has a marketing label 164 disposed thereon.

Containers as described herein may be disposable (preferably recyclable) single-use containers used as product packaging for asparagus, or may be made of thicker or more rugged material for use as a reusable container. Containers as described herein are adapted to store and transport asparagus.

Various embodiments have been described by way of example. It will be apparent to persons skilled in the art that a number of variations and modifications can be made without departing from the scope of the claims.

What is claimed is:

1. A container for asparagus, wherein:
the container has a first end and a second end and a waist disposed between the first end and second end:
the container tapers inwardly from the waist toward the first end and from the waist toward the second end;
the container has a reservoir for containing a volume of water; and
the container is ventilated.

2. The container of claim 1, further comprising:
a quantity of water in the reservoir; and
at least one asparagus spear disposed in the container, each asparagus spear having its white tip in contact with the water.

3. The container of claim 2, wherein each asparagus spear extends substantially transverse to the waist.

4. The container of claim 1, wherein the container comprises:
a base defining the first end of the container; and
a lid defining the second end of the container;
the lid being removably securable to the base;
at least one of the lid and the base being ventilated; and
the base forming the reservoir.

5. The container of claim 4, wherein the waist is formed at a junction between the lid and the base.

6. An assembly, comprising:
a container according to claim 1; and
a handle carried by the container for supporting the container during transport.

7. The assembly of claim 6, wherein the handle is carried by the lid.

8. The container of claim 1, wherein the container has, in cross-section taken through the waist, a substantially triangular profile.

9. The container of claim 1, wherein a periphery of the base adjacent the first end of the container is adapted for obscuring white tips of asparagus.

10. The container of claim 9, the periphery of the base is covered by an adhesive label.

11. The container of claim 4, wherein the base includes ventilation and the reservoir is disposed between the ventilation and the first end of the container.

12. A method of storing asparagus for sale, comprising:
storing a plurality of groups of asparagus spears, wherein:
each group of asparagus spears is disposed in a respective individual ventilated container;
each container has a reservoir containing a respective volume of water;
white tips of the asparagus spears are disposed in contact with the respective volumes of water; and
the containers substantially enclose the respective groups of asparagus spears.

13. The method of claim 12, wherein the container comprises:
a container base, the container base forming the reservoir; and
a container lid removably secured to the container base.

14. The method of claim 13, wherein the lid is transparent.

15. The method of claim 12, wherein each container has a marketing label disposed thereon.

16. A method of packaging asparagus for sale, the method comprising:
providing a container base, the container base forming a reservoir for containing a volume of water;
placing at least one asparagus spear in the container base;
placing a volume of water in the reservoir;
wherein, when the at least one asparagus spear is in the container base and the volume of water is in the reservoir, each white tip of the at least one asparagus spear is disposed in contact with the volume of water while a major portion of the at least one asparagus spear is disposed outside the volume of water; and
removably securing a container lid to the container base to form a complete container, the complete container substantially enclosing the at least one asparagus spear;
wherein at least one of the lid and the base is ventilated.

17. The method of claim 16, further comprising transporting the container, with the at least one asparagus spear disposed therewithin, to a retail environment.

18. The method of claim 17, further comprising displaying the container, with the at least one asparagus spear disposed therewithin, in the retail environment.

19. The method of claim 18, wherein the container lid is transparent.

20. The method of claim 18, wherein the container has a marketing label disposed thereon.
